(19) United States
(12) Patent Application Publication
(10) Pub. No.: US 2024/0242731 A1
(43) Pub. Date: Jul. 18, 2024

(54) INFORMATION PROCESSING METHOD, INFORMATION PROCESSING DEVICE, AND PROGRAM

(71) Applicant: NIPPON TELEGRAPH AND TELEPHONE CORPORATION, Tokyo (JP)

(72) Inventors: Maiko IMOTO, Musashino-shi, Tokyo (JP); Hitoshi SESHIMO, Musashino-shi, Tokyo (JP)

(73) Assignee: NIPPON TELEGRAPH AND TELEPHONE CORPORATION, Tokyo (JP)

(21) Appl. No.: 18/574,325

(22) PCT Filed: Jul. 5, 2021
(86) PCT No.: PCT/JP2021/025358

§ 371 Date: Dec. 27, 2023

(51) Int. Cl. G10L 25/51; G06F 40/279

(52) U.S. Cl. CPC G10L 25/51; G06F 40/279

(57) ABSTRACT

An information processing method according to an embodiment of this invention includes: an acquisition process of acquiring first data from a user terminal; a calculation process of calculating a degree of similarity between a first portion of first document content related to the first data and a second portion of second document content related to a speech voice; a generation process of generating third data in which data of the first portion is associated with second data including at least one of data of the second portion and data of a third portion subsequent to the second portion in the second document content, on the basis of a fact that the degree of similarity is higher than a first threshold; and an output process of outputting the third data to the user terminal.

### TECHNICAL FIELD

Embodiments of this invention relate to an information processing method, an information processing device, and a program.

### BACKGROUND ART

Services for learning by viewing content including image content and audio content are becoming common. While viewing and learning such content, the participants write down the details of the content for later review.

While listening to the voice uttered in audio content (such voice will be hereinafter also referred to as speech voice), a participant may organize the contents of the speech, and write down the contents, using words different from the actually uttered words. It is highly likely that the participant deeply understands the portions he/she has written down in this manner.

However, it is not easy for a participant to perform this task while viewing content. For this reason, participants' attention tends to be directed to writing down the speech without any change (see Non Patent Literature 1, for example).

### CITATION LIST

### Non Patent Literature

Non Patent Literature 1: Pam A. Mueller and Daniel M. Oppenheimer. “The Pen Is Mightier Than the Keyboard: Advantages of Longhand Over Laptop Note Taking”, Psychological Science published online 23 Apr. 2014

### SUMMARY OF INVENTION

### Technical Problem

While a participant's attention is directed to writing down the speech as it is, the participant might miss some spoken contents. In this case, the participant cannot write down the portions he/she has missed. As a result, the participant cannot review the portions he/she has missed.

This invention has been made in view of the above circumstances, and aims to provide a technology for extracting data related to speech voice that may have been missed by a user while the user is recording details spoken in audio content.

### Solution to Problem

To solve the above problem, an information processing method according to an embodiment of this invention is implemented by a device including a hardware processor and a memory, and includes: an acquisition process of acquiring first data from a user terminal; a calculation process of calculating a degree of similarity between a first portion of first document content related to the first data and a second portion of second document content related to a speech voice; a generation process of generating third data in which data of the first portion is associated with second data including data of the second portion and/or data of a third portion subsequent to the second portion in the second document content, on the basis of a fact that the degree of similarity is higher than a first threshold; and an output process of outputting the third data to the user terminal.

### Advantageous Effects of Invention

According to an embodiment of this invention, it is possible to provide a technology for extracting data related to speech voice that may have been missed by a user while the user is recording contents spoken in audio content.

### BRIEF DESCRIPTION OF DRAWINGS

FIG. 1 is a diagram illustrating a schematic configuration of a server device that is used as an information processing device according to a first embodiment of this invention, and a user terminal.

FIG. 2 is a block diagram illustrating an example hardware configuration of the server device that is used as the information processing device according to the first embodiment of this invention, and the user terminal.

FIG. 3 is a block diagram illustrating an example software configuration of a control unit of the server device that is used as the information processing device according to the first embodiment of this invention.

FIG. 4 is a block diagram illustrating an example software configuration of a control unit of the user terminal according to the first embodiment of this invention.

FIG. 5 is a diagram illustrating the structure of data stored in a user document data storage unit of the user terminal according to the first embodiment of this invention.

FIG. 6 is a diagram illustrating the structure of data stored in a content data storage unit of the server device that is used as the information processing device according to the first embodiment of this invention.

FIG. 7 is a diagram illustrating the structure of data stored in a support data storage unit of the server device that is used as the information processing device according to the first embodiment of this invention.

FIG. 8 is a flowchart illustrating an example operation to be performed by the server device that is used as the information processing device according to the first embodiment of this invention, and the user terminal.

FIG. 9 is a diagram for explaining details of an operation to be performed by the server device that is used as the information processing device according to the first embodiment of this invention, under the control of a support data generation unit.

FIG. 10 is a diagram for explaining details of an operation to be performed by the user terminal according to the first embodiment of this invention, under the control of a display data output unit.

### DESCRIPTION OF EMBODIMENTS

The following is a description of embodiments according to this invention, with reference to the drawings. Note that the respective functional blocks shown in the drawings are not necessarily distinguished from one another as illustrated. For example, some functions may be executed by a functional block different from the functional block illustrated in the drawings. Further, the functional blocks illustrated in the drawings may be divided into smaller functional sub-blocks. Also, the names of the functional blocks and the components in the description below are merely for convenience, and do not limit the configurations and operations of the functional blocks and the components.

### First Embodiment

### (Example Configuration)

### (1) Schematic Configuration Diagram

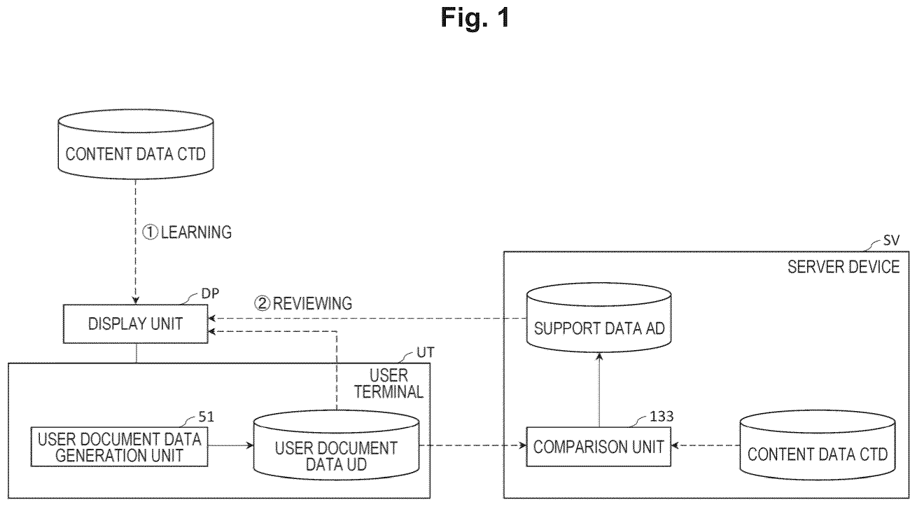

FIG. 1 illustrates a schematic configuration of a server device SV according to a first embodiment of the present invention and a user terminal UT.

The user terminal UT is a smartphone, a mobile terminal (a tablet terminal, for example), a personal computer, or the like, for example. The user terminal UT can transmit and receive data to and from the server device SV. For example, a display unit DP is connected to the user terminal UT. In the description in this specification, the display unit DP is connected to the user terminal UT, but the user terminal UT and the display unit DP may be integrally formed. The display unit DP is a cathode ray tube (CRT) display, a liquid crystal display, an organic electroluminescence (EL) display, or the like, for example.

Using the user terminal UT, a user views content the user wishes to learn (this content will be hereinafter also referred to as learning content), for example. More specifically, the user terminal UT reproduces content data CTD related to learning content, for example, to cause the display unit DP to display image content on its display screen, and cause an output unit (not shown) to output audio content. The user learns through the image content and the audio content. Under the control of a user document data generation unit 51, the user terminal UT generates user document data UD, on the basis of an input made via a keyboard or the like by the user during learning, for example. This embodiment is described herein on the assumption that learning content includes image content and audio content, but some learning content may include only audio content, for example. Image content is slide content or video image content, for example, and may be a combination of them. Audio content contains speech voice.

The user terminal UT can cause the display unit DP to display document content related to the user document data UD. Through the document content displayed on the display unit DP, the user can review the learning content he/she has learned in the past.

The user terminal UT can transmit the user document data UD to the server device SV prior to such review. Under the control of a comparison unit 133, the server device SV compares the document content related to the user document data UD with the contents of the speech voice related to the content data CTD, and generates support data AD based on the comparison. The support data AD contains data of the document content. The document content relates to the portion of the contents of the speech voice that the user may have missed during the learning. The server device SV transmits the support data AD to the user terminal UT.

The user terminal UT causes the display unit DP to display document content related to the support data AD, together with the document content related to the user document data UD. Through the document content displayed on the display unit DP, the user can review the content learned in the past.

### (2) Hardware Configuration of the Server Device and the User Terminal

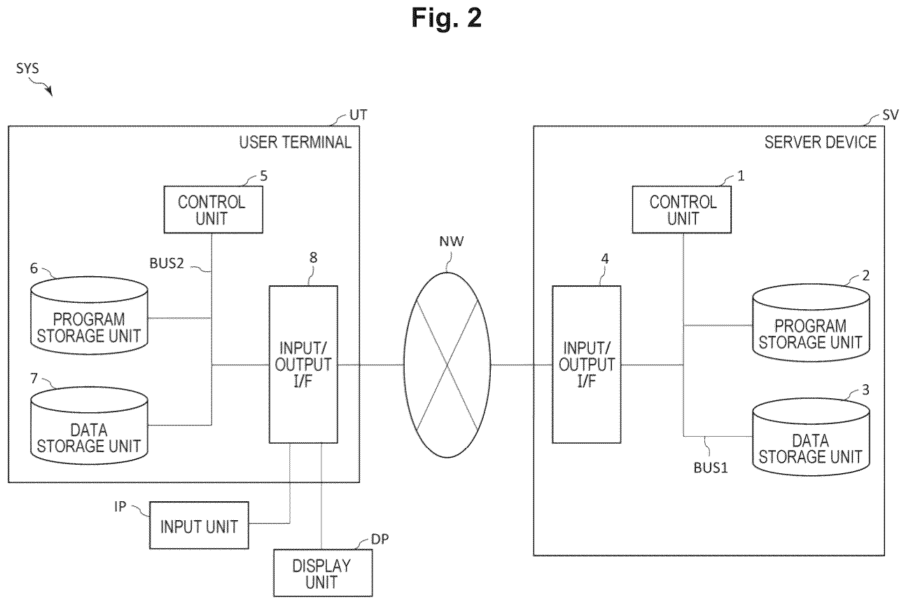

FIG. 2 is a block diagram illustrating an example hardware configuration of the server device SV and the user terminal UT. In this specification, a combination of the server device SV and the user terminal UT is also referred to as the system SYS.

The server device SV includes a control unit 1, a program storage unit 2, a data storage unit 3, an input/output interface (input/output I/F) 4, and a bus BUS1. The program storage unit 2, the data storage unit 3, and the input/output interface 4 are connected to the control unit 1 via the bus BUS1.

The control unit 1 includes a hardware processor such as a central processing unit (CPU).

The program storage unit 2 as a storage medium is a combination of a nonvolatile memory into and from which writing and reading data can be performed at any time, such as a hard disk drive (HDD) or a solid state drive (SSD), and a nonvolatile memory such as a read only memory (ROM), for example. The program storage unit 2 stores a program to be used for performing various control processes according to this embodiment, in addition to middleware such as an operating system (OS).

The data storage unit 3 as a storage medium is a combination of a nonvolatile memory into and from which writing and reading can be performed at any time, such as an HDD or an SSD, and a volatile memory such as a random access memory (RAM), for example. The data storage unit 3 is used as a work area of the hardware processor included in the control unit 1, temporarily holds data, and functions as a buffer and a cache.

Under the control of the control unit 1, the input/output interface 4 transmits and receives data to be transmitted to and from the user terminal UT, using a communication protocol defined by a communication network NW. The input/output interface 4 is formed with an interface compatible with a cable LAN or a wireless LAN, for example.

The user terminal UT includes a control unit 5, a program storage unit 6, a data storage unit 7, an input/output interface 8, and a bus BUS2. The program storage unit 6, the data storage unit 7, and the input/output interface 8 are connected to the control unit 5 via the bus BUS2.

Explanation of the control unit 5 can be the same as that of the control unit 1. Explanation of the program storage unit 6 can be the same as that of the program storage unit 2. Explanation of the data storage unit 7 can be the same as that of the data storage unit 3, except that the control unit 1 is replaced with the control unit 5. Explanation of the input/output interface 8 can be the same as that of the input/output interface 4, except that the control unit 1 is replaced with the control unit 5, and the user terminal UT is replaced with the server device SV.

For example, an input unit IP and the display unit DP are connected to the input/output interface 8. The input unit IP is a keyboard, a mouse, a touch-pad, or the like, for example. The input unit IP and the display unit DP may be formed with a touch panel.

### (3) Software Configuration Related to the Server Device

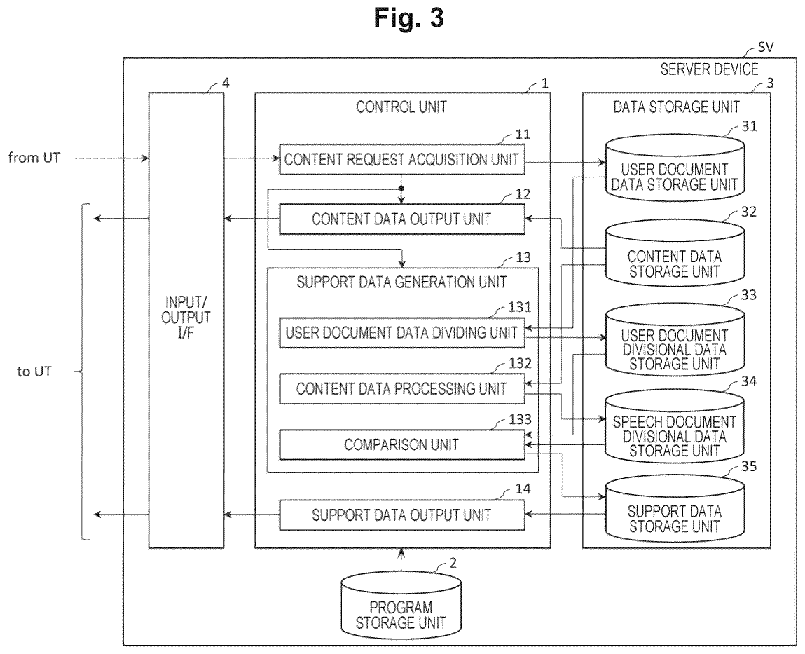

FIG. 3 is a block diagram illustrating an example software configuration of the control unit 1 of the server device SV. FIG. 3 also illustrates components related to transmission and reception of data related to each process to be performed under the control of the software configuration. The same applies to the similar drawings described later.

The control unit 1 includes a content request acquisition unit 11, a content data output unit 12, a support data generation unit 13, and a support data output unit 14, for example. The processing function of each component included in the control unit 1 is implemented by the control unit 1 causing the hardware processor of the control unit 1 to execute a program stored in the program storage unit 2. Although the description has been made on the assumption that the program stored in the program storage unit 2 is used, the program to be used may be provided through the communication network NW.

The input/output interface 4 receives a content request transmitted from the user terminal UT via the communication network NW, and inputs the content request to the control unit 1. The input/output interface 4 receives data output from the control unit 1, and transmits the data to the user terminal UT via the communication network NW in accordance with an instruction from the control unit 1.

The data storage unit 3 includes a user document data storage unit 31, a content data storage unit 32, a user document divisional data storage unit 33, a speech document divisional data storage unit 34, and a support data storage unit 35, for example.

The user document data storage unit 31 stores the user document data UD and an identifier of learning content related to the user document data UD.

The content data storage unit 32 stores the content data CTD and the identifier of the learning content related to the content data CTD. Although the description herein is based on the assumption that the content data storage unit 32 is included in the server device SV, the content data storage unit 32 may be provided in cloud computing, for example.

The user document divisional data storage unit 33 and the speech document divisional data storage unit 34 store the data being processed by the support data generation unit 13.

The support data storage unit 35 stores the support data AD.

The content request acquisition unit 11 performs a process of acquiring a content request transmitted from the user terminal UT via the input/output interface 4. The content request includes the user document data UD and an identifier of learning content related to the user document data UD. For example, the content request acquisition unit 11 performs a process of storing the user document data UD and the identifier into the user document data storage unit 31. In this storing process, the user document data UD is associated with the identifier.

The content data output unit 12 performs a process of reading the content data CTD associated with the identifier from the content data storage unit 32, outputting the content data CTD to the outside of the server device SV via the input/output interface 4, and transmitting the content data CTD to the user terminal UT.

The support data generation unit 13 performs a process of generating the support data AD, on the basis of the user document data UD and the content data CTD. More specifically, the process is performed as follows.

The support data generation unit 13 includes a user document data dividing unit 131, a content data processing unit 132, and the comparison unit 133, for example.

The user document data dividing unit 131 reads the user document data UD from the user document data storage unit 31, and performs a process of generating data obtained by dividing the user document data UD (the data will be hereinafter also referred to as user document divisional data). More specifically, the process is performed as follows. The user document data dividing unit 131 performs, for each portion obtained by dividing document content related to the user document data UD into several portions, a process of generating user document divisional data that is data of the portions. The user document data dividing unit 131 performs a process of storing the generated user document divisional data into the user document divisional data storage unit 33.

The content data processing unit 132 reads the content data CTD from the content data storage unit 32, and performs a process of generating data of document content in which the contents of speech voice related to the content data CTD are shown in a document (the data will be hereinafter also referred to as speech document data).

The content data processing unit 132 performs a process of generating data obtained by dividing the speech document data (the data will be hereinafter also referred to as speech document divisional data). More specifically, the process is performed as follows. The content data processing unit 132 performs, for each portion obtained by dividing document content related to the speech document data into several portions, a process of generating speech document divisional data that is data of the portions. The content data processing unit 132 performs a process of storing the generated speech document divisional data into the speech document divisional data storage unit 34.

The comparison unit 133 reads certain user document divisional data from the user document divisional data storage unit 33, reads certain speech document divisional data from the speech document divisional data storage unit 34, and performs a process of comparing document content related to the user document divisional data with document content related to the speech document divisional data. In the comparison process, a process of calculating the degree of similarity between the two pieces of document content is performed. The comparison unit 133 performs a process of determining whether the speech document divisional data corresponds to the user document divisional data, on the basis of the degree of similarity. In a case where the comparison unit 133 determines that the speech document divisional data corresponds to the user document divisional data, the processes described below are performed. Note that the speech document divisional data for which the determination has been made will be hereinafter also referred to as the corresponding speech document divisional data.

The comparison unit 133 performs a process of reading certain speech document divisional data from the speech document divisional data storage unit 34. The speech document divisional data is data of the portion subsequent to the portion related to the corresponding speech document divisional data (the data will be hereinafter also referred to as the subsequent speech document divisional data) in the document content related to the original speech document data. The comparison unit 133 performs a process of storing the user document divisional data, the corresponding speech document divisional data, and the subsequent speech document divisional data into the support data storage unit 35. In the storing process, the corresponding speech document divisional data and the subsequent speech document divisional data are associated with the user document divisional data.

The comparison unit 133 can also perform the same processes as those described above, for other combinations of user document divisional data and speech document divisional data. As a result, combinations of user document divisional data, and the corresponding speech document divisional data and the subsequent speech document divisional data associated with the user document divisional data are sequentially stored into the support data storage unit 35. The data stored into the support data storage unit 35 in this manner is the support data AD to be used in this embodiment.

The support data output unit 14 performs a process of reading the support data AD from the support data storage unit 35, outputting the support data AD to the outside of the server device SV via the input/output interface 4, and transmitting the support data AD to the user terminal UT.

### (4) Software Configuration Related to the User Terminal

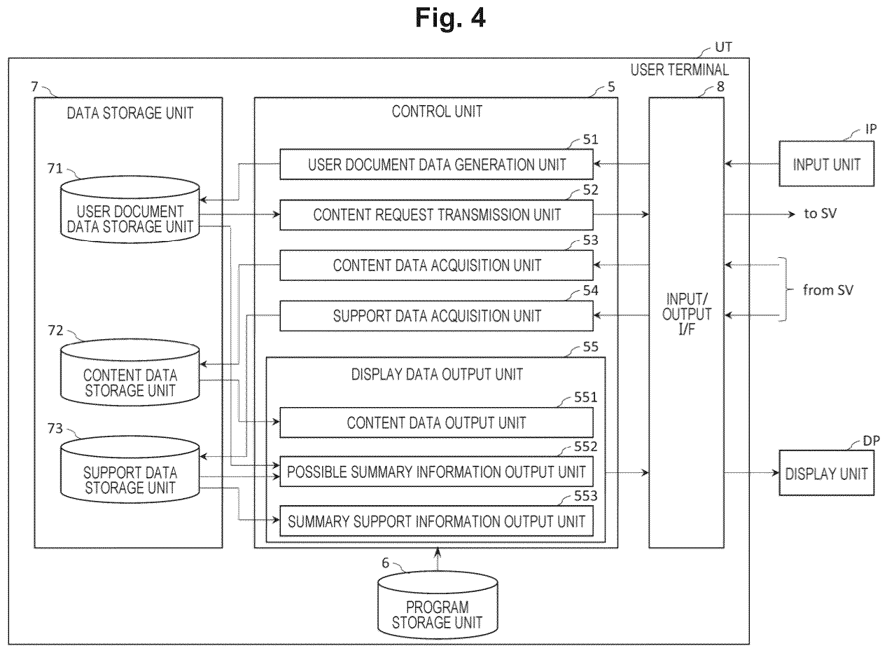

FIG. 4 is a block diagram illustrating an example software configuration of the control unit 5 of the user terminal UT.

The control unit 5 includes the user document data generation unit 51, a content request transmission unit 52, a content data acquisition unit 53, a support data acquisition unit 54, and a display data output unit 55, for example. The processing function of each component included in the control unit 5 is implemented by the control unit 5 causing the hardware processor of the control unit 5 to execute a program stored in the program storage unit 6. Although the description has been made on the assumption that the program stored in the program storage unit 6 is used, the program to be used may be provided through the communication network NW.

The input/output interface 8 receives a content request output from the control unit 5, and transmits the content request to the server device SV via the communication network NW in accordance with an instruction from the control unit 5. The input/output interface 8 receives content data CTD and support data AD transmitted from the server device SV via the communication network NW, and inputs the content data CTD and the support data AD to the control unit 5.

The data storage unit 7 includes a user document data storage unit 71, a content data storage unit 72, and a support data storage unit 73, for example.

The user document data storage unit 71 stores the user document data UD and an identifier of learning content related to the user document data UD.

The content data storage unit 72 stores the content data CTD.

The support data storage unit 73 stores the support data AD.

The user document data generation unit 51 performs a process of generating user document data UD, and storing the user document data UD and an identifier of learning content related to the user document data UD into the user document data storage unit 71. In this storing process, the user document data UD is associated with the identifier.

The process of generating the user document data UD is based on an input via the input unit IP by the user who is learning the learning content, for example. The user document data UD generated in this manner may include, for some portions in document content related to the data UD, information about the time when the input related to the portions has been made by the user.

The content request transmission unit 52 performs the processes described below, in accordance with an input made by the user via the input unit IP, for example. That is, the content request transmission unit 52 reads user document data UD and an identifier of learning content related to the user document data UD from the user document data storage unit 71, and performs a process of generating a content request including the user document data UD and the identifier. The content request transmission unit 52 performs a process of transmitting the content request to the server device SV via the input/output interface 8.

The content data acquisition unit 53 performs a process of acquiring content data CTD transmitted from the server device SV via the input/output interface 8. The transmission of the content data CTD by the server device SV is performed in response to the content request acquired by the server device SV. The content data CTD is associated with the identifier and is stored by the server device SV. The content data acquisition unit 53 performs a process of storing the content data CTD into the content data storage unit 72.

The support data acquisition unit 54 performs a process of acquiring support data AD transmitted from the server device SV via the input/output interface 8. The transmission of the support data AD by the server device SV is performed in response to the content request acquired by the server device SV. The support data AD has been generated by the server device SV on the basis of the above user document data UD, for example. The support data acquisition unit 54 performs a process of storing the support data AD into the support data storage unit 73.

The display data output unit 55 performs a process of reading the user document data UD from the user document data storage unit 71, reading the content data CTD from the content data storage unit 72, and reading the support data AD from the support data storage unit 73. The display data output unit 55 performs a process of outputting information based on the user document data UD, the content data CTD, and the support data AD, to the display unit DP via the input/output interface 8. More specifically, the process is performed as follows.

The display data output unit 55 includes a content data output unit 551, a possible summary information output unit 552, and a summary support information output unit 553, for example.

The content data output unit 551 performs a process of outputting the content data CTD to the display unit DP.

The possible summary information output unit 552 performs a process of outputting information based on the user document data UD and the user document divisional data in the support data AD, to the display unit DP.

The summary support information output unit 553 performs a process of outputting the speech document divisional data in the support data AD to the display unit DP.

### (5) Data Structure

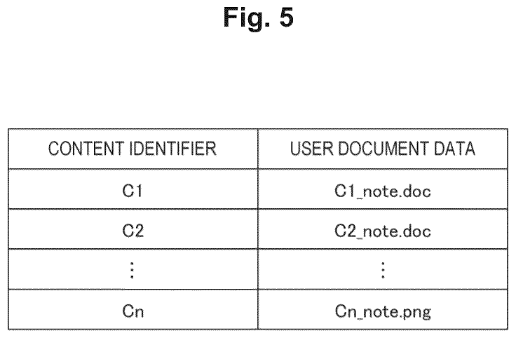

FIG. 5 illustrates the structure of data stored in the user document data storage unit 71.

The user document data storage unit 71 includes a column of identifiers of learning content (hereinafter also referred to as content identifiers), and a column of user document data. In the user document data storage unit 71, data related to one piece of learning content is stored as one record. FIG. 5 illustrates an example of several records stored in the user document data storage unit 71 as described below.

When certain user document data UD is stored into the user document data storage unit 71, as a certain record, the identifier of learning content related to the user document data UD is stored into the column of content identifiers, and the user document data UD is stored into the column of user document data.

The identifier is used to uniquely identify the learning content.

The user document data UD has been generated on the basis of an input made via the input unit IP such as a keyboard by a user who is learning the learning content, but is not limited to this. In a case where the user terminal UT is equipped with a camera like a smartphone, for example, the data UD may relate to image content in which character information written by the user on a note that is physically present is captured and generated with the camera. Alternatively, in a case where the user terminal is a tablet or laptop personal computer, for example, the data UD may relate to image content generated by storing character information written with a stylus pen or a finger. The file format of the data UD generated in this manner is represented by an extension “.doc”, an extension “.pdf”, an extension “.png”, and the like, for example, but is not limited to them.

As described above, in the user document data storage unit 71, the identifier and the user document data UD are associated with each other, and are stored as one record.

In this embodiment, a case where the user document data UD relates to document content including text information is described as an example. However, this embodiment is not limited to this case. In a case where the user document data UD relates to image content, before the process of generating user document divisional data, the user document data dividing unit 131 performs a process of generating data of document content obtained by extracting character information from the image content, using a technology of optical character recognition (OCR), for example. The user document data dividing unit 131 performs, on the data, the process to be performed on the user document data UD as described above.

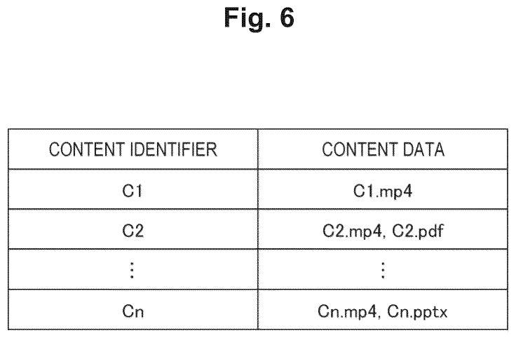

FIG. 6 illustrates the structure of data stored in the content data storage unit 32.

The content data storage unit 32 includes a column of content identifiers and a column of content data. In the content data storage unit 32, data related to one piece of learning content is stored as one record. FIG. 6 illustrates an example of several records stored in the content data storage unit 32 as described below.

As one record in the content data storage unit 32, the identifier of certain learning content is stored in the column of content identifiers, and the content data CTD related to the learning content is stored in the column of content data.

The identifier is used to uniquely identify the learning content. In the example illustrated in FIG. 6, the same identifier as that used as the identifier of the learning content in the example in FIG. 5 is used as the identifier of the certain learning content.

The content data CTD may be formed with one file, or may be formed with a plurality of files. The file (s) constituting the content data CTD may relate to image content such as slide content and video image content, or may relate to audio content. The file format of such files is represented by an extension “.mp4”, an extension “.mov”, an extension “.pdf”, an extension “.pptx”, and the like, for example, but is not limited to them.

As described above, in the content data storage unit 32, the identifier and the content data CTD are associated with each other, and are stored as one record.

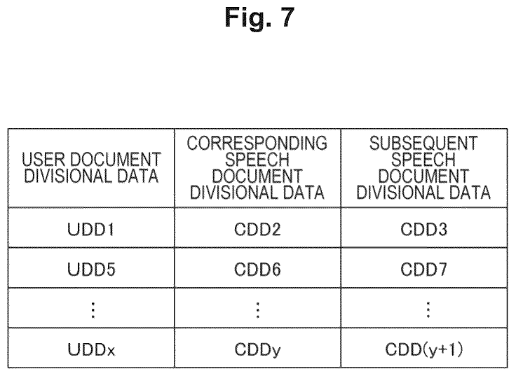

FIG. 7 illustrates the structure of data stored in the support data storage unit 35.

The support data storage unit 35 includes a column of user document divisional data, a column of the corresponding speech document divisional data, and a column of the subsequent speech document divisional data, for example. FIG. 7 illustrates an example of several records stored in the support data storage unit 35 as described below.

When certain user document divisional data UDD is stored into the support data storage unit 35, the data UDD is stored into the column of the user document divisional data, the corresponding speech document divisional data CDD corresponding to the data UDD is stored into the column of the corresponding speech document divisional data, and the subsequent speech document divisional data CDD related to the data UDD is stored into the column of the subsequent speech document divisional data, as a record.

As described above, in the support data storage unit 35, the data UDD, the corresponding speech document divisional data CDD, and the subsequent speech document divisional data CDD are associated with one another, and are stored as one record.

The description of this embodiment is based on the assumption that the corresponding speech document divisional data CDD and the subsequent speech document divisional data are associated with the user document divisional data UDD, and are stored as the support data AD in the support data storage unit 35. However, only either the corresponding speech document divisional data CDD or the subsequent speech document divisional data may be stored as the support data AD. In this case, the support data storage unit 35 may not include the column of the corresponding speech document divisional data or the column of the subsequent speech document divisional data described above.

### (Example Operation)

Next, an example operation of the system SYS formed as above is described.

### (1) Operation Flow

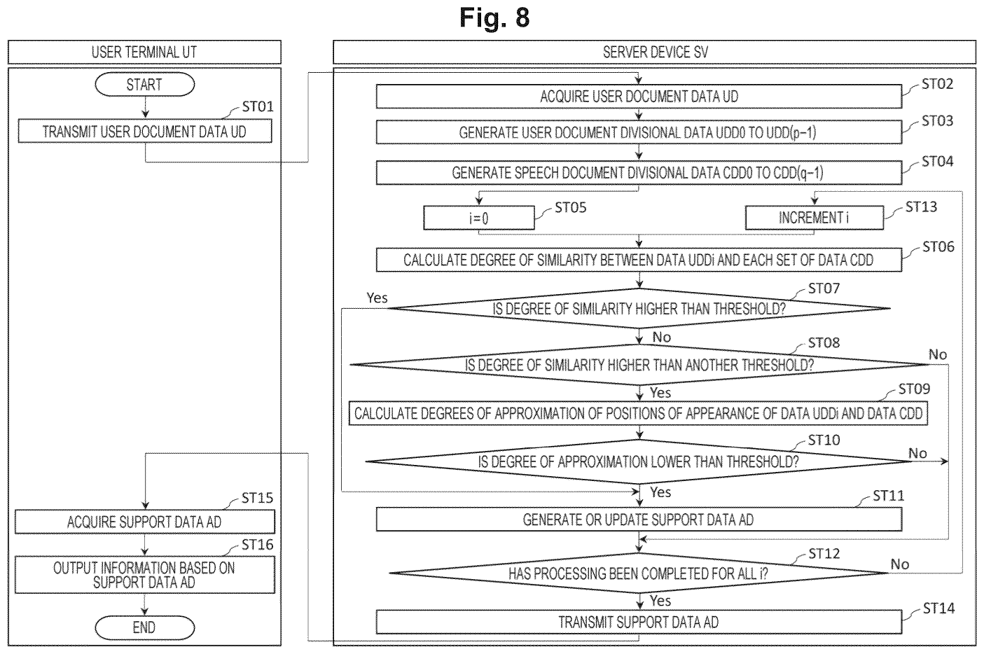

FIG. 8 is a flowchart illustrating an example operation to be performed by the server device SV and the user terminal UT. The operation described below is merely an example, and operations according to this embodiment are not limited to this.

Prior to the operation, the user views learning content, for example, using the user terminal UT. Under the control of the user document data generation unit 51, the control unit 5 of the user terminal UT generates user document data UD on the basis of an input made via the input unit IP by the user during learning, and stores the user document data UD and the identifier of the learning content into the user document data storage unit 71. When reviewing the learning content, the user makes an input to the user terminal UT via the input unit IP, for example. The operation illustrated in the flowchart in FIG. 8 is started by the input from the user, for example.

Under the control of the content request transmission unit 52, the control unit 5 of the user terminal UT reads the user document data UD from the user document data storage unit 71, and transmits a content request containing the user document data UD to the server device SV (ST01). The content request also contains the identifier.

Under the control of the content request acquisition unit 11, the control unit 1 of the server device SV acquires the user document data UD via the content request (ST02). In response to the content request, the control unit 1 may read the content data CTD associated with the identifier from the content data storage unit 32, and transmit the content data CTD to the user terminal UT, under the control of the content data output unit 12.

Under the control of the user document data dividing unit 131, the control unit 1 generates, for each portion obtained by dividing the document content related to the user document data UD into several portions, user document divisional data UDD that is the data of the portions (ST03). The user document divisional data UDD generated in this manner is referred to as the user document divisional data UDD0, the user document divisional data UDD1, the user document divisional data UDD2, . . . , and the user document divisional data UDD(p−1) (p being an integer of 2 or greater) in order of the user's recording of the portions of the document content related to the original user document data UD. Under the control of the user document data dividing unit 131, the control unit 1 stores the generated user document divisional data UDD into the user document divisional data storage unit 33.

Subsequently, the control unit 1 generates speech document divisional data CDD, under the control of the content data processing unit 132 (ST04). More specifically, the process is performed as follows.

The control unit 1 reads the content data CTD associated with the identifier from the content data storage unit 32, and generates speech document data that is data of document content showing the contents of the speech voice related to the content data CTD in a document. The process of generating the speech document data is performed with a speech recognition technology, for example. The control unit 1 generates, for each portion obtained by dividing the document content related to the speech document data into several portions, speech document divisional data CDD that is the data of the portions. The speech document divisional data CDD generated in this manner is referred to as the speech document divisional data CDD0, the speech document divisional data CDD1, the speech document divisional data CDD2, . . . , and the speech document divisional data CDD(q−1) (q being an integer of 2 or greater) in order of utterance of portions in the speech voice related to the content data CTD. The control unit 1 stores the generated speech document divisional data CDD into the speech document divisional data storage unit 34.

Note that the operation denoted by ST03 and described above (this operation will be hereinafter also referred to as the operation in ST03; the same applies in other similar descriptions), and the operation in ST04 may be performed in reverse order, or may be performed in a partially overlapping manner.

Subsequently, the control unit 1 generates the support data AD as described below.

First, the control unit 1 sets the value of a variable i to 0, under the control of the comparison unit 133 (ST05).

Subsequently, the control unit 1 reads the user document divisional data UDDi from the user document divisional data storage unit 33, under the control of the comparison unit 133. At this point of time, the user document divisional data UDD0 is read out. Under the control of the comparison unit 133, the control unit 1 reads the speech document divisional data CDD0 from the speech document divisional data storage unit 34. Under the control of the comparison unit 133, the control unit 1 calculates the degree of similarity between the document content related to the user document divisional data UDDi and the document content related to the speech document divisional data CDD0. The degree of similarity to be calculated has a higher value, when the two target pieces of document content are more similar to each other. Likewise, the control unit 1 reads the speech document divisional data CDD1 from the speech document divisional data storage unit 34, and calculates the degree of similarity between the document content related to the user document divisional data UDDi and the document content related to the speech document divisional data CDD1. Thereafter, under the control of the comparison unit 133, the control unit 1 calculates the degree of similarity between the document content related to the user document divisional data UDDi and the document content related to the speech document divisional data CDDj in the same manner as above, in each case where the integer j is an integer from 0 to (q−1) (ST06).

The control unit 1 performs the operation described below for the highest degree of similarity, for example, among the degrees of similarity calculated in this manner.

Under the control of the comparison unit 133, the control unit 1 determines whether the degree of similarity is higher than a threshold VSH (ST07).

If the degree of similarity is determined to be higher than the threshold VSH (ST07, Yes), the control unit 1 determines that the speech document divisional data CDD used for calculating the degree of similarity is the speech document divisional data CDD corresponding to the user document divisional data UDDi, under the control of the comparison unit 133, and performs the operation described below.

The control unit 1 reads the subsequent speech document divisional data CDD from the speech document divisional data storage unit 34. The subsequent speech document divisional data CDD is data of the portion subsequent to the portion related to the corresponding speech document divisional data CDD in the document content related to the original speech document data. The control unit 1 stores the user document divisional data UDDi, the corresponding speech document divisional data CDD, and the subsequent speech document divisional data CDD into the support data storage unit 35. In the storing process, the data UDDi is associated with the corresponding speech document divisional data CDD and the subsequent speech document divisional data CDD. The data stored in the support data storage unit 35 is the support data AD to be used in this embodiment, and the support data AD is generated or updated by the storing process (ST11).

If the degree of similarity is determined not to be higher than the threshold VSH (ST07, No), the control unit 1 determines whether the degree of similarity is higher than a threshold VSM, under the control of the comparison unit 133 (ST08). The threshold VSM is lower than the threshold VSH.

If the degree of similarity is determined to be higher than the threshold VSM (ST08, Yes), the control unit 1 calculates, under the control of the comparison unit 133, the degree of approximation between the position of the document content related to the user document divisional data UDDi in the document content related to the original user document data UD and the position of the speech voice related to the speech document divisional data CDD used in calculating the degree of similarity in the speech voice related to the content data CTD (ST09). The closer the two target positions are, the lower the degree of approximation to be calculated becomes. Under the control of the comparison unit 133, the control unit 1 determines whether the degree of approximation is lower than a threshold VN (ST10).

If the degree of approximation is determined to be lower than the threshold VN (ST10, Yes), the control unit 1 determines that the speech document divisional data CDD is the speech document divisional data CDD corresponding to the user document divisional data UDDi, under the control of the comparison unit 133, and performs the operation in ST11.

After the operation in ST11 or if the degree of similarity is determined not to be higher than the threshold VSM (ST08, No), or if the degree of approximation is determined not to be lower than the threshold VN (ST10, No), the control unit 1 determines whether the processing has been completed for all “i”, under the control of the comparison unit 133 (ST12). At this point of time, the processing has not been performed in any case where “i” is not 0. If the processing has not been completed for all i as described above (ST12, No), the control unit 1 increments the value of the variable i by 1, under the control of the comparison unit 133 (ST13).

Subsequently, the control unit 1 repeats processing related to the next user document divisional data UDD, starting from the operation in ST06. The control unit 1 repeats the operation from ST06 to ST13 in this manner, and updates the support data AD to be stored in the support data storage unit 35 every time performing the operation in ST11.

In the operation in ST12 subsequent to the processing related to the user document divisional data UDD(p−1), the control unit 1 determines that the processing has been completed for all “i”. In this case (ST12, Yes), under the control of the support data output unit 14, the control unit 1 reads the support data AD from the support data storage unit 35, and transmits the support data AD to the user terminal UT (ST14).

The control unit 5 of the user terminal UT acquires the support data AD, under the control of the support data acquisition unit 54 (ST15).

Under the control of the display data output unit 55, the control unit 5 outputs information based on the support data AD to the display unit DP (ST16). Through the content displayed on the display screen of the display unit DP, the user can review the content he/she has learned in the past.

The above example operation is merely an example of an operation to be performed by the server device SV and the user terminal UT.

The above description concerns a case where the operations in ST07 to ST11 are performed for the highest degree of similarity among the calculated degrees of similarity. However, these operations may be performed for each of the calculated degrees of similarity. In this case, after these operations are performed for each of the calculated degrees of similarity, the process moves on to the operation in ST12.

Further, the operation in ST07 and the operation in ST08 described above may be performed in reverse order. In this case, the operation is performed as described below. First, a check is made to determine whether the degree of similarity is higher than the threshold VSM. If the degree of similarity is determined not to be higher than the threshold VSM, the process moves on to the operation in ST12. If the degree of similarity is determined to be higher than the threshold VSM, a check is made to determine whether the degree of similarity is higher than the threshold VSH. If the degree of similarity is determined to be higher than the threshold VSH, the process moves on to the operation in ST11. If the degree of similarity is determined not to be higher than the threshold VSH, the process moves on to the operation in ST09.

Further, the operation in ST09 described above may be performed before the operation in ST07 and the operation in ST08, for example. Following the operation in ST06, the operation in ST09 is performed for the speech document divisional data CDD used in the calculation of the highest degree of similarity, for example. Following this operation, the operation in ST07 and the subsequent operations are performed.

Further, as described above, in a case where the operations in ST07 to ST11 are performed for each of the calculated degrees of similarity, the operation in ST09 may be performed for each piece of speech document divisional data CDD before the operation in ST06 or in parallel with the operation in ST06.

### (2) Details of the Support Data Generation Process to be Performed by the Server Device

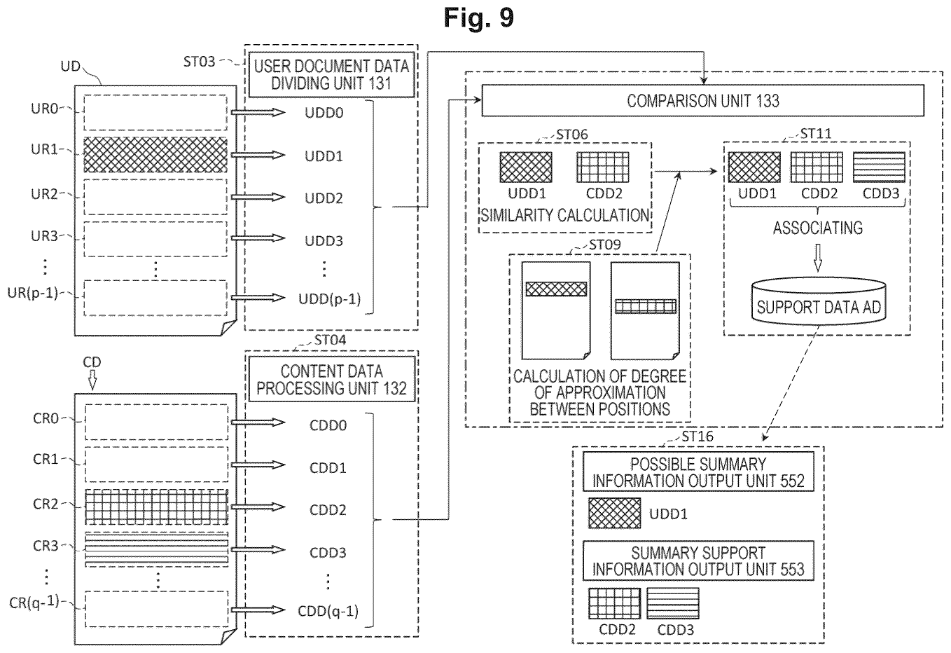

FIG. 9 is a diagram for explaining the details of the operation in each ST to be performed under the control of the support data generation unit 13 of the server device SV as described above with reference to FIG. 8.

First, the operation in ST03 is described.

In document content related to the user document data UD, grouping using a plurality of regions UR is performed, as illustrated in FIG. 9. More specifically, the document content is divided into document content in a region UR0, document content in a region UR1, document content in a region UR2, document content in a region UR3, . . . , and document content in a region UR(p−1) in order of the user's recording of the document content.

Such grouping is performed as described below, for example.

For each row of the document content, grouping may be performed so that the character information included in the row forms one group. Alternatively, grouping may be performed on the basis of the co-occurrence frequency between adjacent words in the document content. Also, grouping may be performed on the basis of the blank spaces in the document content. Alternatively, grouping may be performed on the basis of a topic analysis technique. Also, grouping may be performed so that the areas of the plurality of regions UR become substantially the same.

In the operation in ST03 in the example illustrated in FIG. 8, under the control of the user document data dividing unit 131, the user document divisional data UDD0 that is the data of the document content in the region UR0 is generated, the user document divisional data UDD1 that is the data of the document content in the region UR1 is generated, the user document divisional data UDD2 that is the data of the document content in the region UR2 is generated, the user document divisional data UDD3 that is the data of the document content in the region UR3 is generated, . . . , and the user document divisional data UDD(p−1) that is the data of the document content in the region UR(p−1) is generated.

Next, the operation in ST04 is described.

Speech document data is generated on the basis of the content data CTD. In document content related to the speech document data, grouping using a plurality of regions CR is also performed, as illustrated in FIG. 9. More specifically, the document content is divided into document content in a region CR0, document content in a region CR1, document content in a region CR2, document content in a region CR3, . . . , and document content in a region CR (q−1) in order of utterance in the speech voice related to the original content data CTD.

Such grouping is performed as described below, for example.

For each row of the document content, grouping may be performed so that the character information included in the row forms one group. Alternatively, grouping may be performed on the basis of the co-occurrence frequency between adjacent words in the document content. Also, grouping may be performed on the basis of the blank spaces in the document content. The blank spaces correspond to the sections in which there is no speech voice, for example. Alternatively, grouping may be performed on the basis of a topic analysis technique. Also, grouping may be performed so that the areas of the plurality of regions UR become substantially the same. The area of each region UR can be proportional to the utterance duration of the document content in the region, for example.

In the operation in ST04 in the example illustrated in FIG. 8, under the control of the content data processing unit 132, the speech document divisional data CDD0 that is the data of the document content in the region CR0 is generated, the speech document divisional data CDD1 that is the data of the document content in the region CR1 is generated, the speech document divisional data CDD2 that is the data of the document content in the region CR2 is generated, the speech document divisional data CDD3 that is the data of the document content in the region CR3 is generated, . . . , and the speech document divisional data CDD(q−1) that is the data of the document content in the region CR (q−1) is generated.

Next, regarding some operations in ST to be performed under the control of the comparison unit 133, an example case where these operations are performed for the user document divisional data UDD1 is described.

In the operation in ST06 in the example illustrated in FIG. 8, the degree of similarity between the document content related to the user document divisional data UDD1 and the document content related to the speech document divisional data CDDj is calculated in each case where the integer j is an integer from 0 to (q−1). Of these cases, a case where the integer j is 2 is illustrated in FIG. 9.

The similarity calculation process may be based on how similar the character strings and/or the topics are between the two target pieces of document content. The similarity calculation process may be based on techniques that vary depending on the granularity of grouping. For example, the similarity calculation process may be based on the length of the longest common character string between the two target pieces of document content. Alternatively, the similarity calculation process may be based on the word co-occurrence rate between the two target pieces of document content. The word co-occurrence rate is based on (the number of co-occurring characters)/(the number of characters in the document content), for example. Alternatively, the similarity calculation process may be based on a topic analysis technology.

The description below is based on the assumption that, of the degrees of similarity calculated in this manner, the degree of similarity between the document content related to the user document divisional data UDD1 and the document content related to the speech document divisional data CDD2 is the highest.

In the operations in ST07 and ST08 in the example illustrated in FIG. 8, the highest degree of similarity is compared with thresholds.

In a case where the degree of similarity is higher than the threshold VSH, it is determined that the user document divisional data UDD1 corresponds to the speech document divisional data CDD2 used in the calculation of the highest degree of similarity, and the operation in ST11 is performed.

In a case where the degree of similarity is not higher than the threshold VSH but is higher than the threshold VSM in the operation in ST08 in the example illustrated in FIG. 8, the process described below is performed in the operation in ST09 in the example in FIG. 8.

The degree of approximation between the position of the document content related to the user document divisional data UDD1 in the document content related to the original user document data UD and the position of the speech voice related to the speech document divisional data CDD2 in the speech voice related to the content data CTD is calculated.

The position of the document content related to the user document divisional data UDD1 in the document content related to the user document data UD is indicated by the numerical value of (the area of the region UR0 before the region UR1 related to the data UDD1)/(the sum of the areas of the regions UR), for example.

Alternatively, in a case where the user document data UD includes, for some portions in the document content related to the data UD, information about the time when the input related to the portions has been made by the user, the position may be determined as described below. That is, the position may be indicated by the numerical value of (the period since the user started the input for the document content related to the data UD until the user started the input for the document content related to the data UDD1)/(the period since the user started the input for the document content related to the data UD until the user completed the input).

The position of the speech voice related to the speech document divisional data CDD2 in the speech voice related to the content data CTD is indicated by the numerical value of (the period from the start of the speech voice related to the content data CTD till the start of the speech voice related to the data CDD2)/(the period from the start till the end of the speech voice related to the content data CTD), for example.

Alternatively, the position may be indicated by the numerical value of (the sum of the areas of the regions CR0 and CR1 before the region CR2 related to the data CDD2)/(the sum of the areas of the regions CR), for example.

The degree of approximation is calculated from the absolute value of the difference between these two numerical values.

In a case where the degree of approximation is lower than the threshold VN, it is determined that the speech document divisional data CDD2 corresponds to the user document divisional data UDD1, and the operation in ST11 is performed.

In the operation in ST11 in the example illustrated in FIG. 8, the data UDD1, the corresponding speech document divisional data CDD2, and the subsequent speech document divisional data CDD3 are stored as the data in the support data AD. In the support data AD, the data UDD1 is associated with the corresponding speech document divisional data CDD2 and the subsequent speech document divisional data CDD3.

The user document divisional data UDD1, the speech document divisional data CDD2, and the speech document divisional data CDD3, which are associated in this manner in the support data AD, are used in the operation in ST16 in the example in FIG. 8. More specifically, the user document divisional data UDD1 is used under the control of the possible summary information output unit 552, and the speech document divisional data CDD2 and CDD3 are used under the control of the summary support information output unit 553. This is described below in greater detail, with reference to the next drawing.

### (3) Details of the Information Output Process to be Performed by the User Terminal on the Basis of Support Data

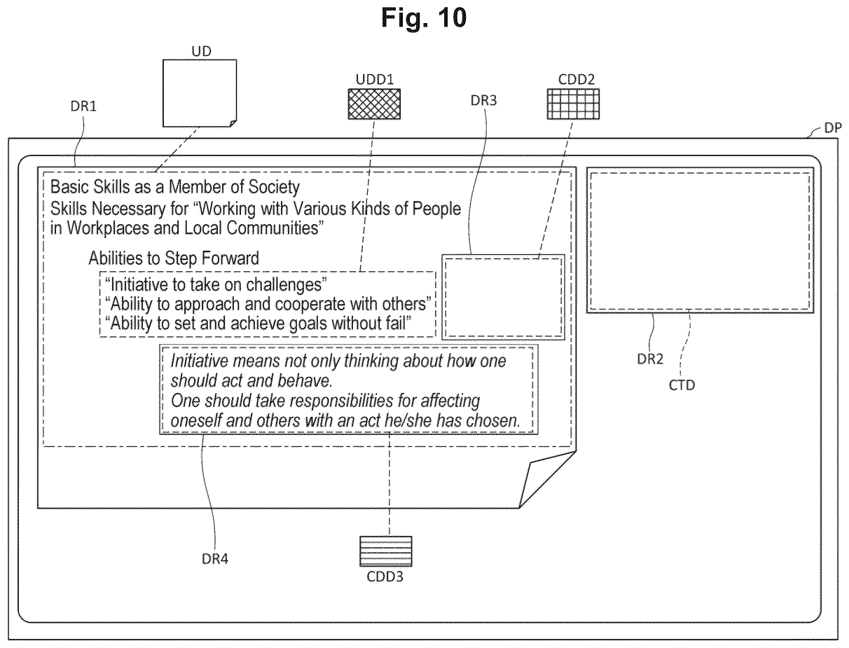

FIG. 10 is a diagram for explaining the details of the operation in ST16 to be performed under the control of the display data output unit 55 of the user terminal UT as described above with reference to FIG. 8. The dashed-line frames and the dot-and-dash frame in the drawing are shown for ease of explanation, and are not images to be displayed on the display screen of the display unit DP.

On the display screen of the display unit DP connected to the user terminal UT, a display region DR1 and a display region DR2 are displayed, for example.

In the display region DR1, the document content related to the user document data UD is displayed, under the control of the possible summary information output unit 552. In the display region DR2, the image content related to the content data CTD is displayed, for example, under the control of the content data output unit 551.

In the display region DR1, of the document content related to the user document data UD, the document content related to the user document divisional data UDD contained in the support data AD is displayed in a highlighted manner, under the control of the possible summary information output unit 552. In FIG. 10, the highlighted document content is interposed between “<<” and “>>”. In FIG. 10, the highlighted document content related to the user document divisional data UDD1 in the support data AD is surrounded by a dashed-line frame. Note that, in the display region DR1, the document content related to the user document data UD may not be displayed, but only the document content related to the user document divisional data UDD in the support data AD may be displayed in a highlighted manner, under the control of the possible summary information output unit 552.

For example, in a case where a cursor displayed on the display screen of the display unit DP is placed on certain highlighted document content on the basis of an operation performed by the user, a display region DR3 and a display region DR4 are displayed on one of the upper, lower, left, and right sides of the document content on the display screen, for example, under the control of the summary support information output unit 553. FIG. 10 illustrates an example case where the cursor is placed on the document content related to the highlighted user document divisional data UDD1.

In the display region DR3, the document content related to the corresponding speech document divisional data CDD2 associated with the data UDD1 in the support data AD is displayed, under the control of the summary support information output unit 553.

In the display region DR4, the document content related to the subsequent speech document divisional data CDD3 associated with the data UDD1 in the support data AD is displayed, under the control of the summary support information output unit 553.

### Effects

The server device SV according to the first embodiment acquires user document data UD from the user terminal UT. The user document data UD has been generated on the basis of an input made by a user who is learning certain learning content. The server device SV generates user document divisional data UDD, on the basis of the user document data UD. The user document divisional data UDD is data of a certain portion in the document content related to the original user document data UD. Meanwhile, the server device SV reads the content data CTD related to the learning content, and generates speech document data that is data of document content showing the contents of the speech voice related to the content data CTD in a document. The server device SV generates speech document divisional data CDD, on the basis of the speech document data. The speech document divisional data CDD is data of a certain portion in the document content related to the original speech document data. The server device SV calculates the degree of similarity between the document content related to the user document divisional data UDD and the document content related to the speech document divisional data CDD.

On the basis of the degree of similarity, the server device SV determines whether the speech document divisional data CDD corresponds to the user document divisional data UDD. In a case where the server device SV determines that the speech document divisional data CDD corresponds to the user document divisional data UDD, the server device SV stores the user document divisional data UDD, the corresponding speech document divisional data CDD, and the subsequent speech document divisional data CDD into the support data storage unit 35. The subsequent speech document divisional data CDD is data of the portion subsequent to the portion related to the corresponding speech document divisional data CDD in the document content related to the original speech document data. In the storing process, the user document divisional data UDD is associated with the corresponding speech document divisional data CDD and the subsequent speech document divisional data CDD. In this manner, support data AD is generated in the support data storage unit 35. The server device SV transmits the support data AD to the user terminal UT.

There is a high possibility that the document content related to the user document divisional data UDD in the support data AD is a record of the contents that have been uttered in the learning content and been recorded without any change by the user. There is a possibility that the user does not deeply understand the recorded portion. Therefore, as described above with reference to FIG. 10, when the document content related to the data UDD is displayed on the display screen of the display unit DP in a highlighted manner, the user can easily recognize the portion of which the speech voice contents have been recorded without any change, and can efficiently review the learning content. For example, the user can organize the contents of the highlighted document, and then summarize and record the contents again in some other expression.

Further, as described above with reference to FIG. 10, the document content related to the speech document divisional data CDD associated with the data UDD in the support data AD can be displayed on the display screen. Specifically, this display is conducted as follows. The document content related to the corresponding speech document divisional data CDD can be displayed. Further, the document content related to the subsequent speech document divisional data CDD can be displayed. The document content displayed in this manner shows, in a document, the speech voice that the user may have missed because the user concentrated on recording the uttered contents without any change. Accordingly, using the document content displayed in this manner, the user does not need to view the learning content again to listen to the portion that has been missed, and thus, can efficiently do a review. The user can summarize the contents of the document displayed in a highlighted manner as described above, while referring to the document content displayed in this manner. In a case where the granularity of the grouping described above with reference to FIG. 9 is large, the display of the document content related to the corresponding speech document divisional data CDD can be more useful for the user, for example. In a case where the granularity of the grouping is small, the display of the document content related to the subsequent speech document divisional data CDD can be more useful for the user, for example.

The server device SV determines whether the speech document divisional data CDD corresponds to the user document divisional data UDD in the manner described below in greater detail. In a case where the degree of similarity is higher than the threshold VSH, the server device SV determines that the data CDD corresponds to the data UDD. In a case where the degree of similarity is not higher than the threshold VSH but is higher than the threshold VSM, the following processing is performed. The server device SV calculates the degree of approximation between the position of the document content related to the data UDD in the document content related to the original user document data UD and the position of the speech voice related to the data CDD in the speech voice related to the content data CTD. If the degree of approximation is lower than the threshold VN, the server device SV determines that the data CDD corresponds to the data UDD.

For example, in a case where the user records the uttered contents without any change, it is difficult to correctly record the uttered contents word by word. A portion recorded partially different from the uttered contents might not be extracted through simple character string comparison with the uttered contents. This is because such character string comparison is to spot completely matched character strings between the target pieces of character information. On the other hand, the server device SV according to the first embodiment can determine whether speech document divisional data CDD corresponds to user document divisional data UDD, on the basis of the degree of approximation described above, in addition to the degree of similarity between the document content related to the data UDD and the document content related to the data CDD, as described above. Further, the similarity calculation process is not necessarily a process based on character string comparison. Accordingly, the server device SV according to the first embodiment can extract data UDD not to be extracted by a conventional technology, and incorporate the data UDD into the support data AD.

Note that the present invention is not limited to the above embodiments, and various modifications can be made to them at the implementation stage without departing from the scope of the invention. Also, the embodiments may be combined as appropriate, and in that case, a combined effect is achieved. Further, the embodiments described above include various inventions, and various inventions can be extracted through a combination selected from a plurality of disclosed components. For example, even if some components are eliminated from the components described in the embodiments, a configuration from which some components are eliminated can be extracted as an invention, as long as the problem can be solved, and the advantageous effects can be achieved.

### REFERENCE SIGNS LIST

SYS system
SV server device
UT user terminal
NW communication network
1, 5 control unit
2, 6 program storage unit
3, 7 data storage unit
4, 8 input/output interface
BUS bus
IP input unit
DP display unit
11 content request acquisition unit
12 content data output unit
13 support data generation unit
131 user document data dividing unit
132 content data processing unit
133 comparison unit
14 support data output unit
31 user document data storage unit
32 content data storage unit
33 user document divisional data storage unit
34 speech document divisional data storage unit
35 support data storage unit
51 user document data generation unit
52 content request transmission unit
53 content data acquisition unit
54 support data acquisition unit
55 display data output unit
551 content data output unit
552 possible summary information output unit
553 summary support information output unit
71 user document data storage unit
72 content data storage unit
73 support data storage unit
CTD content data
UD user document data
AD support data
UDD user document divisional data
CDD speech document divisional data
UR, CR region
DR display region

1. An information processing method implemented by a device that includes a hardware processor and a memory,
the information processing method comprising:
an acquisition process of acquiring first data from a user terminal;
a calculation process of calculating a degree of similarity between a first portion of first document content related to the first data and a second portion of second document content related to a speech voice;
a generation process of generating third data in which data of the first portion is associated with second data including at least one of data of the second portion and data of a third portion subsequent to the second portion in the second document content, on a basis of a fact that the degree of similarity is higher than a first threshold; and
an output process of outputting the third data to the user terminal.

2. The information processing method according to claim 1, wherein the second data includes the data of the third portion.

3. The information processing method according to claim 1, further comprising:
a second calculation process of calculating a degree of approximation between a position of the first portion in the first document content and a position of a speech voice related to the second portion in the speech voice, when the degree of similarity is not higher than the first threshold but is higher than a second threshold, wherein
the generation process of generating the third data is performed on a basis of a fact that the degree of approximation is lower than a third threshold.

4. The information processing method according to claim 1, further comprising:
a second calculation process of calculating a degree of approximation between a position of the first portion in the first document content and a position of a speech voice related to the second portion in the speech voice, wherein
the generation process of generating the third data is performed on a basis of a fact that the degree of approximation is lower than a third threshold, when the degree of similarity is not higher than the first threshold but is higher than a second threshold.

5. The information processing method according to claim 1, further comprising a second generation process of generating data of the second document content, on a basis of fourth data related to audio content including the speech voice, the fourth data being stored in a storage unit.

6. An information processing device, comprising:
processing circuitry configured to
acquire first data from a user terminal;
calculate a degree of similarity between a first portion of first document content related to the first data and a second portion of second document content related to a speech voice;
generate third data in which data of the first portion is associated with second data including at least one of data of the second portion and data of a third portion subsequent to the second portion in the second document content, on a basis of a fact that the degree of similarity is higher than a first threshold; and
output the third data to the user terminal.

7. A non-transitory computer readable medium storing computer executable instructions which, when executed by a processor, cause the processor to perform a process comprising:
acquiring first data from a user terminal;
calculating a degree of similarity between a first portion of first document content related to the first data and a second portion of second document content related to a speech voice;
generating third data in which data of the first portion is associated with second data including at least one of data of the second portion and data of a third portion subsequent to the second portion in the second document content, on a basis of a fact that the degree of similarity is higher than a first threshold; and
outputting the third data to the user terminal.
